(19) United States
(12) Patent Application Publication
(10) Pub. No.: US 2015/0041297 A1
(43) Pub. Date: Feb. 12, 2015

(54) BUTTON DEVICE OF AUTOMATIC VENDING MACHINE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: YONG-CHANG FAN, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/267,101

(22) Filed: May 1, 2014

(30) Foreign Application Priority Data
Aug. 6, 2013 (CN) 2013103386339

(51) Int. Cl. H01H 13/14

(52) U.S. Cl. CPC H01H 13/14; H01H 2221/03
USPC 200/345

(57) ABSTRACT

A button device includes a circuit board, a switch secured to the circuit board, a button, and a resilient member. The button includes a main body. The main body includes a pressing portion and an extending portion extending from the pressing portion. A resisting portion extends from the pressing portion and abuts the extending portion. A gap is defined between the resisting portion and the circuit board, and a resilient member is attached to the resisting portion. The button is moveable along a direction that is substantially perpendicular to the circuit board to deform the resilient member, and the resisting portion is pressed against the circuit board for preventing the button from further moving along the direction.

### FIELD

The present disclosure relates to button devices, and particularly to a button device used for an automatic vending machine.

### BACKGROUND

Automatic vending machines often include decorating plates and a plurality of button devices attached to the decorating plates. A button device can include a securing panel, a button attached to the securing panel, an extending arm, and a rib. The button is secured to the decorating plate by a soldering process, and the rib is connected to the button by the extending arm. In use, when the button is pressed, the extending arm is deformed to move the rib to open or close an electrical connection of the vending machine.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a button device.

FIG. 2 is similar to FIG. 1, but viewed from a different aspect.

FIG. 3 is an assembled view of the button device of FIG. 1.

FIG. 4 is a cross-sectional view of FIG. 3, taken along line IV-IV, wherein a button of the button device is in a first position.

FIG. 5 is a cross-sectional view of FIG. 3, taken along line V-V.

FIG. 6 is similar to FIG. 5, but the button is in a second position.

FIG. 7 is an assembled view of a plurality of button devices of FIG. 1 used on an automatic vending machine.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

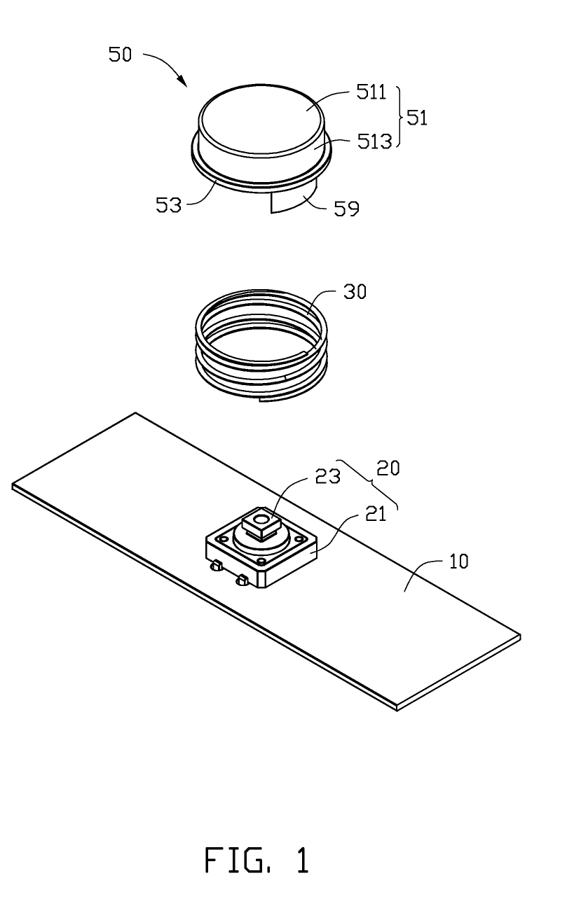

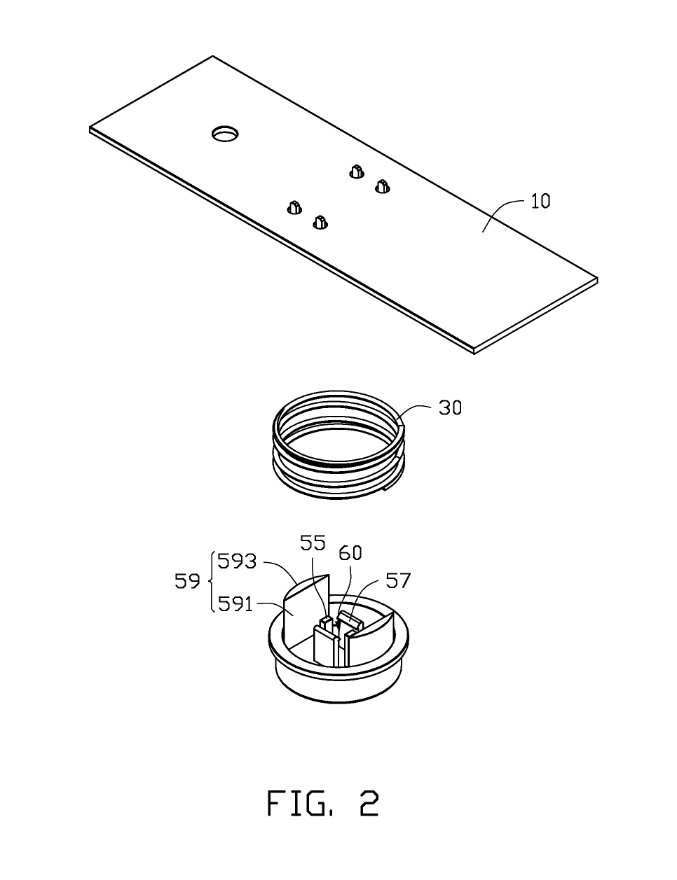

FIGS. 1-2 illustrate an embodiment of a button device. The button device comprises a circuit board 10, a switch 20 attached to the circuit board 10, a resilient member 30, and a button 50. In at least one embodiment, the resilient member 30 is a spring.

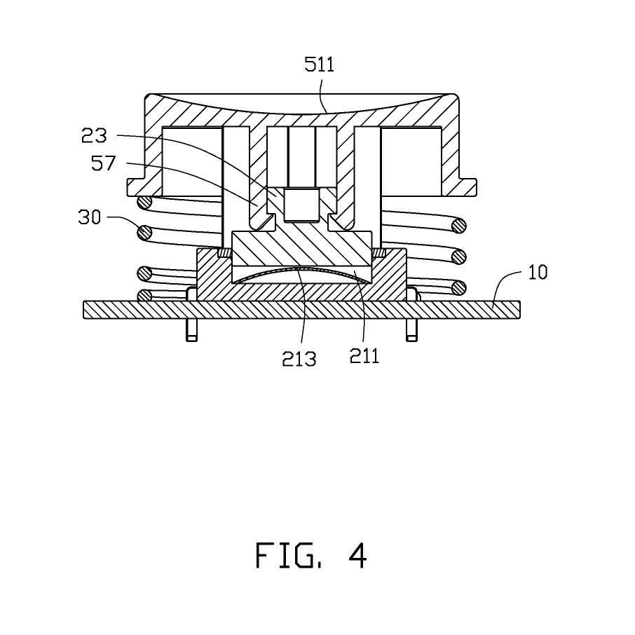

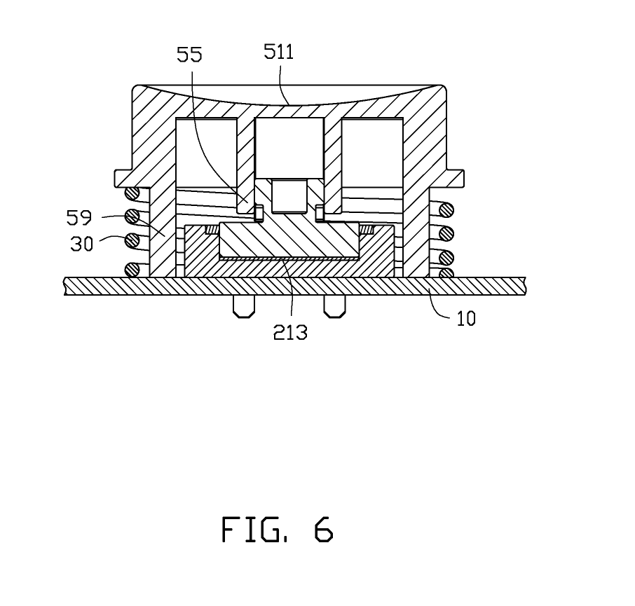

The switch 20 comprises a base frame 21 and a key 23 attached to the base frame 21. The key 23 is used for opening or closing the switch 20. A receiving slot 211 (see FIG. 4) is defined in the base frame 21 for receiving the key 23. A wafer 213 (see FIG. 4) is received in the receiving slot 211 and covers a bottom surface of the receiving slot 211. In at least one embodiment, the wafer 213 is arcuate and deformable to be adhered to the bottom surface of the receiving slot 211 (see FIG. 6).

The button 50 comprises a main body 51, a flange 53 extending around a peripheral end portion of the main body 51, two positioning portions 55, two clipping portions 57, and two resisting portions 59. The main body 51 comprises a pressing portion 511, and an extending portion 513 extending substantially perpendicularly from the pressing portion 511. In at least one embodiment, the extending portion 513 and the pressing portion 511 cooperatively define a cavity (not labeled). A cross-section of each positioning portion 55 is substantially rectangular, and the two positioning portions 55 are substantially parallel to each other. A cross-section of each clipping portion 57 is substantially rectangular, and the two clipping portions 57 are substantially parallel to each other and substantially perpendicular to the two positioning portions 55. The two positioning portions 55 and the two clipping portions 57 cooperatively define a receiving space 60 for receiving the key 23. Each resisting portion 59 extends from the pressing portion 511. In one embodiment, a cross-section of each resisting portion 59 is the shape of a segment of a circle. Each resisting portion 59 comprises a substantially rectangular surface 591 and an arcuate surface 593 connected to the rectangular surface 591. The rectangular surface 591 is substantially parallel to each positioning portion 55 and substantially perpendicular to each clipping portion 57.

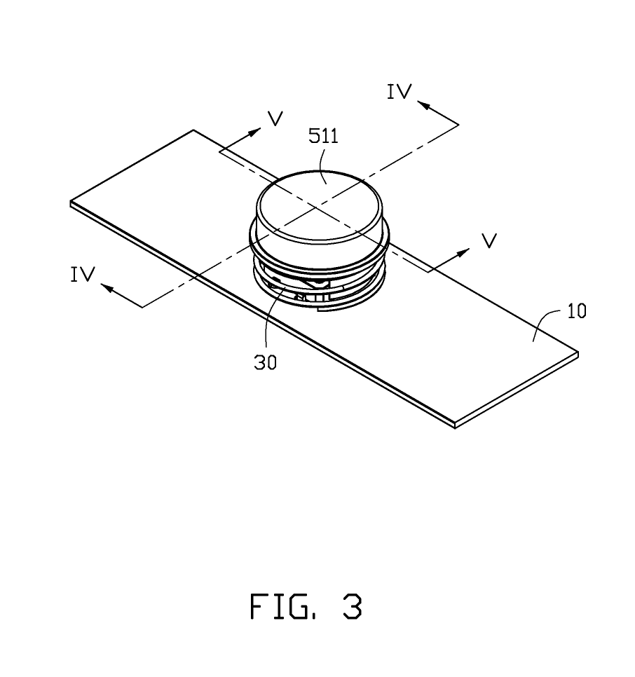

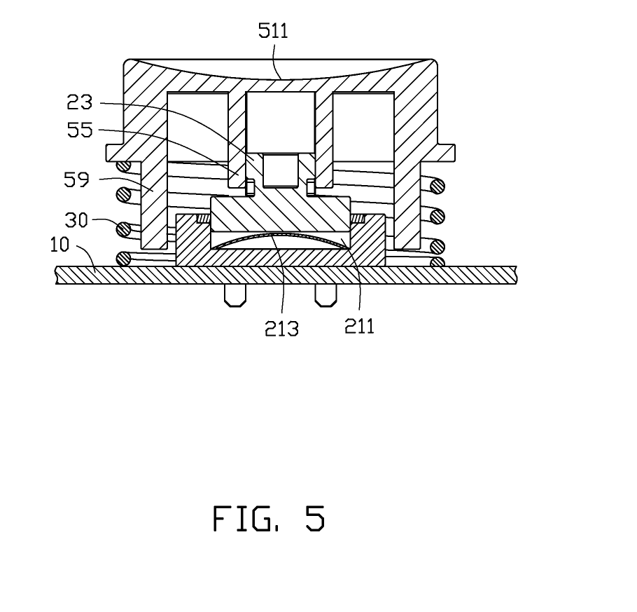

FIGS. 3-5 illustrate assembly of the button device. The resilient member 30 is sleeved on the two resilient portions 59, such that a first end portion of the resilient member 30 resists a surface of the flange 53. The two positioning portions 55 and the two clipping portions 57 surround the key 23, such that the two clipping portions 57 are clipped with two opposite edges of the key 23, to secure the key 23 in the receiving slot 211. Thus, the button 50 is secured to the switch 20. At this time, a second end of the resilient member 30 resists the circuit board 10. The resilient member 30 can be held securely by the arcuate surfaces 593. When the button device is in a first position (see FIG. 5), a gap is defined between each resisting portion 59 and the circuit board 10, and the resilient member 30 is in a relaxed state.

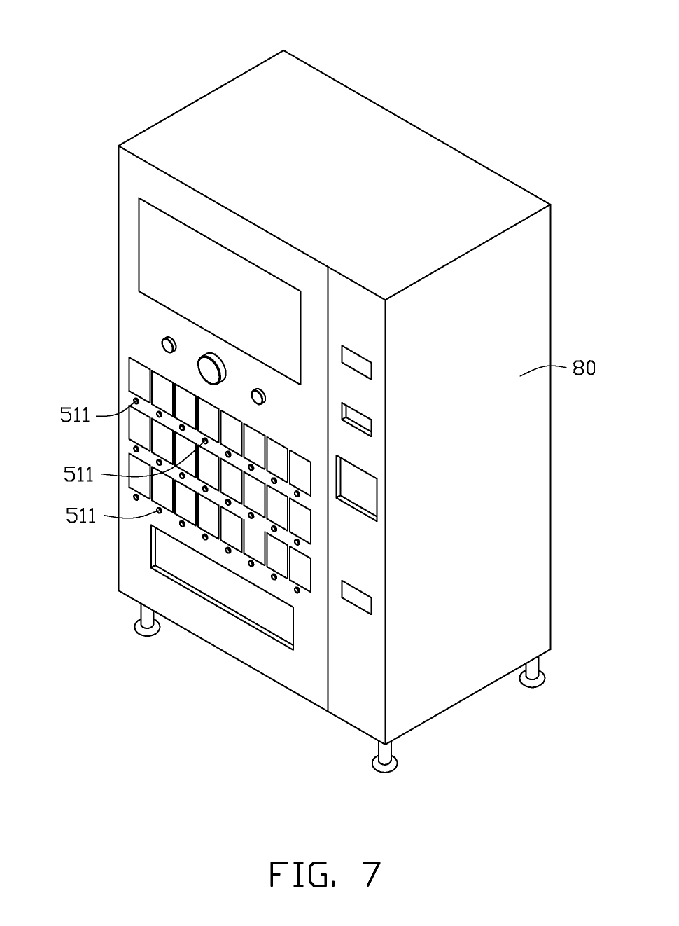

FIGS. 6-7 illustrate an embodiment of using the button device in an automatic vending machine 80. A plurality of button devices can be secured to the automatic vending machine 80 (see FIG. 7). In use, the pressing portion 511 is pressed along a first direction that is substantially perpendicular to the circuit board 10, thereby moving the button 50 along the first direction. The two resisting portions 59 are pressed against the circuit board 10 for preventing the button 50 from further moving along the first direction, so that the button 50 can be moved back easily. At this time, the button device is in a second position (see FIG. 6). In the second position, the resilient member 30 is deformed, and the wafer 213 is deformed to adhere to the bottom surface of the receiving slot 211. When the pressing portion 511 is released, the resilient member 30 and the wafer 213 are restored to move the button 50 along a second direction that is opposite to the first direction.

Even though numerous characteristics and advantages have been set forth in the foregoing description of embodiments, together with details of the structures and functions of the embodiments, the disclosure is illustrative only and changes may be made in detail, including in the matters of shape, size, and arrangement of parts. The disclosed embodiments are illustrative only, and are not intended to limit the scope of the following claims.

What is claimed is:

1. A button device comprising:
a circuit board;
a switch secured to the circuit board;
a button configured for triggering the switch and comprising a main body and a resisting portion connected to the main body; the switch secured to the main body;
a resilient member attached to the resisting portion;
wherein the button is moveable relative to the circuit board between a first position and a second position, when the button is located in the first position, a gap is defined between the resisting portion and the circuit board; and when the button is located in the second position, the resilient member is deformed, and the resisting portion is resisted on the circuit board for preventing the button from moving.

2. The button device of claim 1, wherein the resisting portion comprises an arcuate surface, and the resilient member is secured to the arcuate surface.

3. The button device of claim 2, wherein the switch further comprises a key, the button further comprises a clipping portion, and the clipping portion is clipped to the key.

4. The button device of claim 3, wherein the resisting portion further comprises a rectangular surface connected to the arcuate surface, a cross-section of the clipping portion is substantially a rectangle, and the clipping portion is substantially perpendicular to the rectangular surface.

5. The button device of claim 3, wherein the button further comprises a positioning portion, the positioning portion and the clipping portion cooperatively define a receiving space, and the key is received in the receiving space.

6. The button device of claim 3, wherein the switch further comprises a base frame securing the key and a wafer located in the base frame, the base frame being secured to the circuit board.

7. The button device of claim 6, wherein the base frame defines a receiving slot, the wafer is received in the receiving slot, and the wafer is deformable to adhere to a bottom surface of the receiving slot.

8. The button device of claim 6, wherein the wafer is substantially arcuate.

9. The button device of claim 1, wherein the button further comprises an flange, a first end of the resilient member abuts the flange, and a second end of the resilient member abuts the circuit board.

10. The button device of claim 9, wherein the button further comprises a pressing portion and an extending portion extending from the pressing portion, the flange is connected to the extending portion, and the resisting portion extends from the pressing portion and abuts the extending portion.

11. A button device comprising:
a circuit board;
a switch secured to the circuit board;
a button configured for triggering the switch and comprising a main body, the main body comprising a pressing portion and an extending portion extending from the pressing portion;
a resisting portion extending from the pressing portion and abutting the extending portion;
a gap defined between the resisting portion and the circuit board;
a resilient member attached to the resisting portion;
wherein the button is moveable along a direction that is substantially perpendicular to the circuit board to deform the resilient member, so that the resisting portion is adhered to the circuit board for preventing the button from moving along the direction.

12. The button device of claim 11, wherein the resisting portion comprises an arcuate surface, and the resilient member is secured to the arcuate surface.

13. The button device of claim 12, wherein the switch further comprises a key, the button further comprises a clipping portion, and the clipping portion is clipped to the key.

14. The button device of claim 13, wherein the resisting portion further comprises a rectangular surface connected to the arcuate surface, a cross-section of the clipping portion is substantially a rectangle, and the clipping portion is substantially perpendicular to the rectangular surface.

15. The button device of claim 13, wherein the button further comprises a positioning portion, the positioning portion and the clipping portion cooperatively define a receiving space, and the key is received in the receiving space.

16. The button device of claim 13, wherein the switch further comprises a base frame securing the key and a wafer located in the base frame, the base frame being secured to the circuit board.

17. The button device of claim 16, wherein the base frame defines a receiving slot, the wafer is received in the receiving slot, and the wafer is deformable to adhere to a bottom surface of the receiving slot.

18. The button device of claim 16, wherein the wafer is substantially arcuate.

19. The button device of claim 11, wherein the button further comprises an flange, a first end of the resilient member abuts the flange, and a second end of the resilient member abuts the circuit board.
